(19) United States
(12) Patent Application Publication
(10) Pub. No.: US 2009/0220925 A1
(43) Pub. Date: Sep. 3, 2009

(54) Educational Game

(76) Inventor: Gladys Reihana, Auckland (NZ)

Correspondence Address: JACOBSON HOLMAN PLLC, 400 SEVENTH STREET N.W., SUITE 600, WASHINGTON, DC, 20004, US

(21) Appl. No.: 12/084,772

(22) PCT Filed: Nov. 13, 2006
(86) PCT No.: PCT/NZ2006/000293

§ 371 Date: Apr. 22, 2009

(30) Foreign Application Priority Data
Nov. 11, 2005 (NZ) 543563

(51) Int. Cl. G09B 19/22

(52) U.S. Cl. 434/128

(57) ABSTRACT

An apparatus and method for playing an educational game suitable for one or more players that comprises a question set of ‘priming questions’, a question set of ‘token questions’, one or more substrate to define a playing surface of plural playing zones, wherein each playing zone relates to an individual subject matter and has a pathway of consecutive playing and has (1) a pathway of consecutive playing positions that are marked with an indicia to indicate a priming question, (2) at least one or more playing zones being marked to indicate an association with a token question, (3) each pathway being adapted to continue into and from that of another playing zone; said apparatus also including a movement generator and a playing piece for the players. The rules consist or comprise that when a playing piece becomes associated with a playing position associated with a priming question that player is asked the priming question. If that is incorrectly answered the player passes to the next player. If correctly answered then that first player is asked a token question. Said apparatus for said educational game is characterised in that said primer question facilitates the ability of a player to correctly answer the token questions. Aso disclosed is a playing board that is adjustable in size to suite the number of players and/or duration of game to be played.

### FIELD OF THE INVENTION

This invention relates to educational board games, particularly board games that teach the inter-relationship of two or more concepts.

### BACKGROUND

There are various forms of question and answer entertainment board games that rely on a player, or team of players, answering specific questions in respect of a specific playing square, and whereupon correctly answering that question enables that player to either receive a token or move to a different playing position or the like. A well known example of this is trivial pursuit wherein players move about the board answering questions based on different categories. Each square relates to a single category and when an answer associated with a special “pie” square is answered correctly the player, or players, receive a token. These sorts of games simply question a player in respect of a single category of knowledge, and there is no linkage between each category of knowledge questioned.

Other board games of this type relate to other areas such as careers (see U.S. Pat. No. 5,547,201).

Such prior art board games typically comprise a playing board having a playing surface, and a playing course depicted on that playing surface in the form of a plurality of playing positions (i.e. squares). The squares are arranged in a sequence whereby a player can move between sequential squares answering questions in relation to each square that they land on. A player throws a dice in order to determine the square to which they move, and the game comprises a set of rules which depict the manner in which the players can use the dice and progress throughout the game.

The games of the prior art are limited in their educational usefulness in that they teach pieces of knowledge associated with each square for a particular genre of knowledge associated with the game.

It is apparent that it would be highly desirable to provide a game that can teach complex ideas and associate particular genres of knowledge with other related areas of knowledge such that in answering the series of questions the players are provided with a fundamental basis of knowledge that when associated with knowledge gained through other associated playing areas on the board allows them to answer the “pie” square questions.

It is an object of the present invention to provide an improved educational board game played by one or more players or to at least provide the public with a useful choice.

### BRIEF DESCRIPTION OF THE INVENTION

Other objects of the invention may become apparent from the following description which is given by way of example only.

In a first aspect, the present invention may broadly be said to consist in an apparatus for an educational game comprising a board or other substrate (can be electronic) having at least one region to provide questions to be answered by a player or players, the questions being of a set of questions of a primary kind (“priming question”) and a set of questions of a secondary kind (“token questions”), wherein the rules of the game allows a player to answer a token question, should the player wish or not wish without first answering a priming question, and wherein the content of one or more of the priming questions will be of assistance in answering a token question.

In one embodiment of the present invention there is at least two regions each bearing its own sets of primary and secondary questions and wherein there is a capability of knowledge transfer from one regions sets of questions to the sets of questions of another.

In one embodiment of the invention the rules of the game require a player to answer at least one priming question prior to answering a token question for a given game region.

In a further aspect, the present invention may broadly be said to consist in an apparatus for an educational game played by one or more players comprising
(1) apparatus providing a question set of “priming questions” as herein defined,
(2) apparatus providing a question set of “token questions” as herein defined,
(3) one or more substrates to define a playing surface of plural playing zones, each said playing zone relating to an individual subject matter and each said playing zone having,
   (a) a pathway of consecutive playing positions, at least one or more marked to indicate association with a priming question, and
   (b) at least one or more marked to indicate association with a token question, and
   (c) each pathway being adapted to continue into or from that of another playing zone,
(4) a movement generator for determining movement of said players between said consecutive playing positions,
(5) at least one playing piece per said at least two players,

wherein the rules of the game consist or comprise

when a playing piece of a first player becomes associated with a playing position associated with a priming question, said first player is asked a priming question followed by either one of the following events
(a) upon incorrectly answering said priming question play then passes to a second player who is then asked a priming question, or
(b) upon correctly answering said priming question, said first player is then asked a token question, and

if an incorrect answer to said token question in given, play then passes to a second player who is then asked a priming question, and wherein if a correct answer is given, said player achieves a token, and

wherein said priming questions and said token questions are characterized in that said priming question facilitates the ability of a player to correctly answer said token question.

In one embodiment of the present invention said playing zones form a tessellated surface defining said playing surface. Preferably said playing zones are all of the same shape. Preferably said playing zones are triangle shaped.

In a further aspect, the present invention is a method of teaching the relationship between at least two separate subject matters comprising
(1) apparatus providing a question set of “priming questions” as herein defined,
(2) apparatus providing a question set of “token questions” as herein defined,
(3) one or more substrates to define a playing surface of plural playing zones, each said playing zone relating to an individual subject matter and each said playing zone having,
   (a) a pathway of consecutive playing positions, at least one or more marked to indicate association with a priming question, and
   (b) at least one or more marked to indicate association with a token question, and
   (c) each pathway being adapted to continue into or from that of another playing zone,
(4) a movement generator for determining movement of said players between said consecutive playing positions,
(5) at least one playing piece per said at least two players,

wherein at least one playing area of each said playing zone is associated with a priming question, and

wherein the rules of the game consist or comprise

that when a first player is asked a priming question this is followed by either one of the following events
(a) upon incorrectly answering said priming question play then passes to a second player who is then asked a priming question, or
(b) upon correctly answering said priming question, said first player moves to a new playing position on said playing surface subject to said movement generator, and

wherein if said first player moves to a token question associated playing position said player is asked a token question followed by either one of the following events
(a) upon incorrectly answering said priming question play then passes to a second player who is then asked a priming question, or
(b) upon correctly answering said token question said player achieves a token, and

wherein a token question is based upon a combination of at least two or more said subject matters of a playing zone such that correctly answering questions associated with said two or more playing zones facilitates a player to answer a token question and teaches the relationship between said two or more subject matters of said at least two or more playing zones to said player correctly answering a token question.

Preferably said playing surface comprises at least two or more playing zones.

In one embodiment each said substrate is a playing zone.

Preferably said movement generator is a die or dice.

Preferably when a player incorrectly answers a question, play then passes to a next player (i.e. a second player) who is then asked a priming question.

Preferably, prior to being asked a priming question, said player(s) has landed on a priming question associated playing position after use of said movement generator.

Preferably, prior to being asked a token question, said player(s) has landed on a token question associated playing position after use of said movement generator.

In one embodiment of the invention any player may be asked, and answer, any number of priming questions prior to being asked a token question.

In one embodiment each said each player starts at a different playing position to each other on said playing surface. Preferably each said player starts said game in a different playing zone to each other.

In one embodiment at least one playing area has associated with an additional action (e.g. movement, question, action).

In one embodiment of the present invention each said playing position is associated with at least one each of the following
(1) a next turn action (i.e. play passes to a different player),
(2) a priming question, such that movement of a players playing piece onto said playing position causes a priming question to be asked on said player,
(3) a token question, such that movement of a players playing piece onto said playing position causes a token question to be asked on said player,
(4) a movement action such that a players piece is moved to a predetermined location on said playing surface.

In one embodiment of the present invention a winning condition of said game is to achieve a predetermined number of tokens. In one embodiment of the present invention, said token is in the form of a change in state, indicia, or object. Preferably said token is a segment.

In one embodiment of the present invention one token is issued per playing zone. In alternate embodiments, more than one token is issued per playing zone

In a further aspect, the present invention may broadly be said to consist in an extendable board game assembly played by one or more players comprising
(1) plural substrates (“playing zones”) defining a playing surface, each said playing zone relating to an individual subject matter and each said playing zone having,
(2) a pathway of consecutive playing positions extending between each said at least two playing zones of said playing area, and

wherein the number of playing zones to be used for the game can be predetermined prior to initiation of the game allowing variation in game length, size and difficulty.

In another embodiment of the present invention each said playing zone corresponds to an individual subject matter.

Preferably each said playing zone is attachable to another said playing zone to form said playing surface. Preferably each playing zone can attach to at least one or more of another playing zone. More preferably each playing zone can attach to a plurality of other playing zones.

In one embodiment of the present invention said assembly of playing zones provides a pathway of consecutive playing positions providing a path or paths extending between each of the playing zones forming said playing surface.

Preferably said board game includes a player piece indicative of each player, and able to be moved between said playing positions on said playing surface.

Preferably said playing piece can be moved between each said playing zone along the path of said playing positions.

In one embodiment of the present invention at least one playing position of each playing zone has associated thereto a question. Preferably said board game comprises a plurality of question cards, each having questions and corresponding answers related to said at least one corresponding playing position/question.

In one embodiment of the present invention there is used, in conjunction with said board, a video, CD, DVD, tape, or the like.

Preferably said media provides at least some aspect of said game play, or facilitates said learning of at least one said player or players.

Preferably said games as described is implemented on a computer.

A further aspect of the present invention consists of an apparatus for a board game as aforementioned in conjunction with packaging and/or a rule sheet, at least the packaging and/or rule sheet including direction as to the playing of the game.

In yet a further aspect the present invention consists in a computer conditioning software or software for the purpose of conditioning a computer for the playing of a game of a kind previously defined with respect to apparatus, the board and all forms of markers being replaced by displays to be presented on the computer.

As used herein the term “and/or” means “and” or “or”, or both.

As used herein “(s)” following a noun means the plural and/or singular forms of the noun.

As used herein the term “priming question(s)” refers to a question that helps facilitate a player to answer a “token question”.

As used herein the term “token question(s)” refers to a question that if answered correctly allows the player that correctly answered the question to obtain one or more of a token.

As used herein the term “player” or its derivatives can refer to an individual player or players if one player playing more than one role.

The term “comprising” as used in this specification and claims means “consisting at least in part of”. When interpreting statements in this specification and claims which include that term, the features, prefaced by that term in each statement, all need to be present but other features can also be present. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting

Other aspects of the invention may become apparent from the following description which is given by way of example only and with reference to the accompanying drawings.

### BRIEF DESCRIPTION OF THE DRAWINGS

FIG. 1 involved is a plan view of a board game of the present invention,

FIG. 2 is a plan view of an extendible board game of the present invention showing replacement of playing zones, and

FIG. 3 is a plan view of a board game of Example 1.

### DETAILED DESCRIPTION OF THE INVENTION

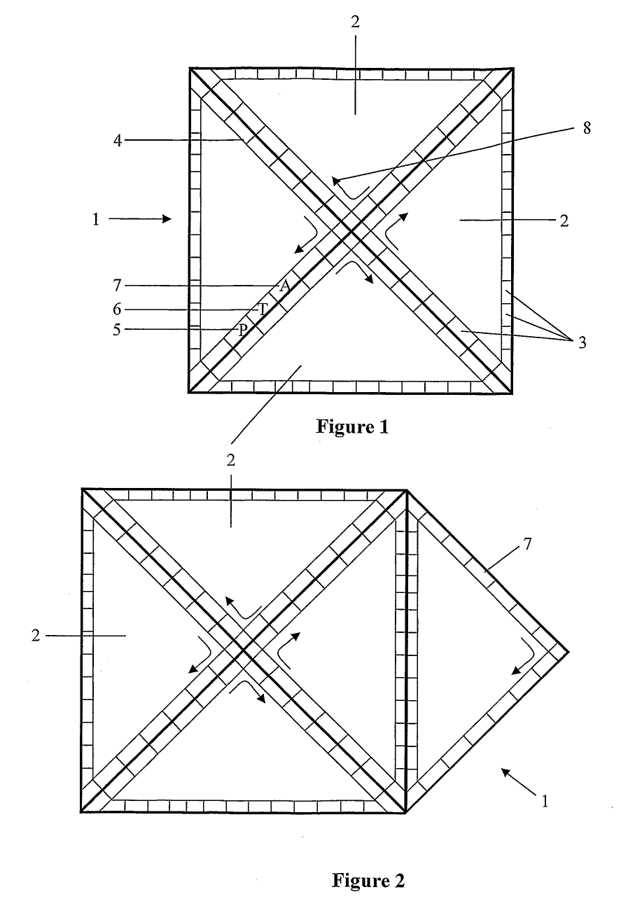

With reference to FIG. 1 there is shown a board game 1 comprising a plurality of playing zones 2 and a pathway of consecutive playing positions 3 forming a playing path 4 extending between each playing zone 2 of said board game 1 area. At least one playing position within each playing zone is marked to indicate an association with a priming question 5. Further squares may also be marked to indicate an association with a token question 6. Further squares may be marked to indicate an association with an additional action 7.

At the start of play the players of the game start with their playing pieces either at predetermined places on the board, or set locations indicated on the board. To determine movement a random generator can be used e.g. dice(s). The dice can be used to determine placement of a players playing piece upon throw of a dice. As a player moves along a playing path 4 they may land on a playing position 3 that is associated with a priming question 5. The other player or players(s) then ask that player who has landed on said priming question associated playing position a priming question. If the question is answered incorrectly then play passes to a next player. This player then beings their turn my throwing a dice and moving to a playing position on the board.

When a player correctly answers a question (i.e. wither priming or token question) that player has the option of continuing in their play.

A player may land on a playing position 3 that is associated with a token question 6. The other player or players(s) then ask they player who has landed on said token position a token question. If the question is answered incorrectly then play passes to a next player. If the question is answered correctly then said player providing a correct answer receives a token. The player may elect to continue in play.

In one embodiment the winning condition is to collect a set number of tokens. In an alternate embodiment the winning condition is the player with the most tokens at one pre-set point in the game, or after a certain amount of time.

In some embodiments each said playing zone 2 may be associated with one token. In alternate embodiments two or more tokens may be available per zone.

In some game-play a player may land on a token question associated playing position 6 before that player has landed on a priming question associated playing position 5 for a particular playing zone 2. It should be appreciated that there are at least two possibilities of action. In one embodiment the rules may require landing on a priming question associated playing position 5 prior to being able to receive a token from landing on a token question associated playing position 6. Alternatively, a player may be free to receive a token following correctly answering a token question despite not have landed on a priming question associated playing position 5 prior.

It should be further appreciated that one advantage of this present invention is that it helps to teach the players a base knowledge. Therefore, if a player is able to answer a token question then it means that they already that that particular aspect of base knowledge.

In one embodiment of the present invention the priming questions are designed to prime a player to correctly answering a token question (i.e. they facilitate correctly answering a token question).

Furthermore, as players move to a different playing zone 2 they are asked priming and token questions from a different genre of questions. The token questions in each zone may require knowledge from two or more zones in order to answer said token questions. Hence, these questions help a player to assimilate knowledge from two or more subject matters for them to be able to correctly answer a token question. This helps to teach said players the link in between various subject mattes such as physiology and diet, and for example diabetes.

As shown in FIG. 2 a further embodiment of the present invention is an extendible board game comprising a plurality of playing zones 2, each of which can be assembled to one another to provide a predetermined number of associated playing zones 2 thus forming a board game 1 area. It should be appreciated that any number of additional playing zones 7 can be connected to one another and therefore provide for a game and length of desired duration. In addition, said additional playing zones can be matched with one another to provide for a degree of variation and/or difficulty in said game. It should be appreciated that such replacement of playing zones 2 enables a wide variation in game play as numerous combinations of playing zones 2 can be placed in combination to form said playing area of said board game 1.

The present embodiment demonstrates a playing surface formed from a tessellated association of triangle shaped playing zones 2. It should be appreciated that the playing zones 2 could be of an alternate geometrical shape, e.g. share etc.

It should also be appreciated that the board and/or game can be represented electronically and thus simulated in a nationalised form.

### Example 1

In one embodiment said board game 1 relates to biological and/or medical subject matter. A first playing zone 2 relates to questions on pharmacology. As a player moves their playing piece along the playing path 4 in the movement direction 8 they may land on a priming question 5 playing positions 3. If so, said player is asked questions that relate to pharmacology. Should an incorrect answer be given then the turn is passed to a second player. If a correct answer is given, then said player further moves around the board 1 until landing on a playing position 3 associated with a token question 6. Prior to landing on a said token associated playing position, that player may land on other playing locations associated with other events (e.g. action. priming question), first. Said token question relates to pharmacology and is linked to the priming question such that answering of a priming question primes the player to correctly answer the token question. It should be appreciated that one or more priming questions may be required to provide the necessary knowledge to prime said player to answer correctly a token question.

In one embodiment of the present invention once a token question is correctly answered relating to a playing zone 2 said player then moves their playing piece along said playing pathway 4 to an adjacent playing zone 2 wherein should they land on a said playing position 3 associated with a priming question they are further asked a priming question. Said adjacent playing zone may be associated with another biological or medical subject matter associated to said first playing zone 2. For example, said second playing zone 2 may relate to cardiac questions. Posing of priming questions within said playing zone 2 relating to cardiac questions further teaches the player aspects of a cardiac nature. Such that when said player lands on playing position 3 associated with a token questions 6, said token question may require knowledge gained from answering the priming questions of at least two or more playing zones, for example, cardiac or pharmacology subject matters. Said token question may therefore relate to a subject matter which combines both cardiac and pharmacological subject matter such as diabetes.

Other playing zones within said playing area may relate to respiratory questions, advanced knowledge, physiology, psychology, or any other number of subject matters.

It should be appreciated that the genus of questions of the board game 1 itself can be varied.

It should be apparent from the above that the answering of multiple priming questions enables a player to answer more complex token questions which assimilate that knowledge gained in answering priming questions. This enables a player to recognise the relationship between two or more subject matters and thus teaches the relationship to the player.

It should be appreciated that this method provides an effective tool for teaching complex information to players and can be used in the genres of subject matter which relate to combinations of numerous discreet entities.

### Example 2

Described as following is a board game based on principles of Māori Health. Such a board game is important in helping Māori, who number high in adverse health statistics, in relating to an educational game.

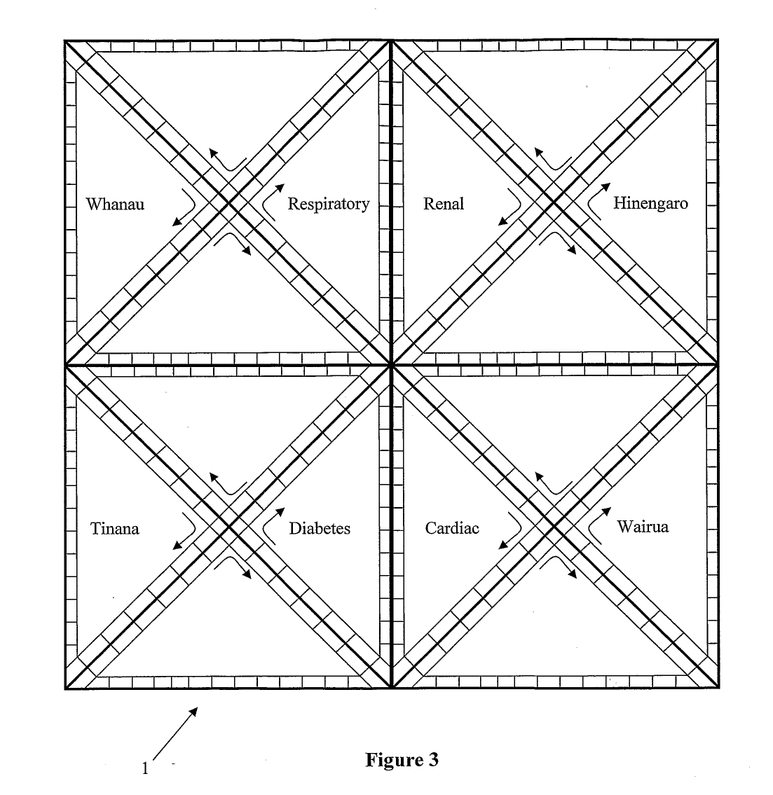

As shown in FIG. 3 is a board game based on the four cornerstones for Māori health being Whanau (family), Tiiana (physical), Hinengaro (mental) and Wairua (spiritual). In this particular example these four models are reflected in four subject areas of health being: respiratory, diabetes, renal and cardiovascular.

In this example these traditional concepts are linked in with the areas of biology and health by designing the questions such that they help Māori to associate between traditional concepts and modern health concepts. The questions are designed to highlight the links between a number of different subject matters to teach the consequences of action in one area of life (e.g. food/nutrition and diet—[kia]) on health (e.g. cardiovascular, diabetes etc). Other lifestyle components that are targeted include physical activity (Korikori tinana), medication (Rongoa) and smoking cessation (Auahi kore).

Of importance is being able to teach, by use of said board game, the relevance of multiple areas of health to each other, and to teach the interconnectedness of lifestyle choices with overall health.

Furthermore, by highlighting the interconnectedness of the various areas of health, the game questions can also help the player to recognise the relevance of such subject matters on the wider aspects of their lives. For example, in respect of their own self determination (Tino rangatiratanga)—i.e. by recognising that their actions contribute directly to their health the player is able to take control of their health through control of their lifestyle; their family connections (Whaka whanaungatanga); their children/generations (Mokopuna); Maori customs and values (Māoritanga).

When all of these concepts are placed together they help build the platforms that are essential for promoting Māori health.

Once the number of playing zones are agreed upon the zones are connected together to form the playing surface. Each player has an individual playing piece which is placed on a starting square found on each playing zone. In some examples, only one player can start in each zone (i.e. one player per zone). A first player then throws a dice to determine their movement.

A player can be moved to a playing position which may be associated with any number of actions of the following:

1. If a player lands on a priming question associated square then that player is asked a priming question. If a correct answer is given then the player continues in their play. If an incorrect answer is given then play passes to the next player.

2. If a player lands on a token question associated square then that player is asked a token question. If an incorrect answer is given then play passes to the next player. If a correct answer is then said player receives a token and then resumes their play.

3. The player lands on a action associated square. The player performs whatever action is associated with that action square.

It should be appreciated that variations on this game play can be included. For example, it may be that a player is not able to answer a token question until they have answered at least one priming question per playing zone.

It should be appreciated also that the length of play can be varied. For example, a player may continue in their play until an incorrect answer is given. Alternatively, it may be stipulated that a player can only answer a certain number of questions before play passes to another player.

As the playing path connects the playing zones, players can pass between adjacent playing zones and should they correctly answer primary questions and token questions then that player can obtain a token.

If a player correctly answers a token question per playing zone, they receive a token associated with that playing zone.

Tokens can be of any shape or indication. In one embodiment the tokens each represent a different concept or object. For example, there can be eight tokens, each representing one of either: family (Whakapapa), mountain (Maunga), river (Awa), subtribe (Hapu), Tribe (Iwi), meeting house (Marae), home (Kaing a noho), and region (Takiwa).

It should be appreciated that the game win position can be based on a number of events. For example, it could be based on a player receiving a certain number of tokens (e.g. eight), earning a pre-determined number of tokens, or based on the player having the most amount of tokens after a particular period of time. It should also be appreciated that each playing zone can be associated with one or more tokens, especially when a reduced number of playing zones is used. For example, if eight playing zones are used then one token could be associated with each playing zone. However, if for example, four playing zones are used then there is a possibility that one token can be associated per playing zone or more than one i.e. two. In this instance each player will need to earn two tokens per playing zone.

In one embodiment of the preset invention the board game is presented in conjunction with an audiovisual device (e.g. video, DVD etc) that will help enhance and/or facilitate the learning experience.

In one aspect said video may present the health concepts through the use of metaphorical analogies. For example, the use of environmental/geographical landscape/plantations/waters. In this example the river corresponds to normal blood flow in an artery. The inclusion of mud patches, branches, weeds reflects cholesterol deposits, and the degree of hardening resembles the impact that smoking can cause (i.e. arteriosclerosis). Other concepts include the use of floods representing high blood pressure in an artery. This can be used to show that after a rain free days, vascular resistance, stroke volume and contractility will revert towards normal parameters.

This metaphorical expression can be further enhance by introducing other elements, such as animals of the environment, which represent other facets of biology (e.g. HDL cholesterol).

Although the invention has been described by way of example and with reference to particular embodiments, it is to be understood that modifications and/or improvements may be made without departing from the scope or spirit of the invention.

1-51. (canceled)

52. An apparatus for an educational game for at least one or more player or players, or apparatus simulating or notionalising an apparatus for an educational game for at least one or more player or players (“educational game”), comprising
(1) apparatus providing a question set of “priming questions” as herein defined,
(2) apparatus providing a question set of “token questions” as herein defined,
(3) one or more substrates to define a playing surface of plural playing zones, each said playing zone relating to an individual subject matter and each said playing zone having,
(a) a pathway of consecutive playing positions, at least one or more marked to indicate association with a priming question, and
(b) at least one or more marked to indicate association with a token question, and
(c) each pathway being adapted to continue into or from that of another playing zone,
(4) a movement generator for determining movement of said players between said consecutive playing positions,
(5) at least one playing piece per said at least one or more players,
wherein the rules of the game consist or comprise
when a playing piece of a player becomes associated with a playing position associated with a priming question,
(A) said player is asked a priming question,
(B) if a correct answer is given to a priming question then said player is then asked a token question,
(C) if a correct answer is given to a token question then that player achieves a token,
wherein if a player incorrectly answers either a priming question or a token question, then play passes to a different player (if two or more players) who, as per (A) above, is asked a priming question, and
wherein said priming questions and said token questions are characterised in that said priming question facilitates the ability of a player to correctly answer said token question.

53. The apparatus of claim 52 where said playing zones form a tessellated surface defining said playing surface.

54. The apparatus of claim 52 wherein each said substrate is a playing zone.

55. The apparatus of any claim 52 wherein at least one playing position has associated with an additional action.

56. The apparatus of claims 55 wherein each said playing position is associated with at least one each of the following
(1) a next turn action (i.e. play passes to a different player),
(2) a priming question, such that movement of a players playing piece onto said playing position causes a priming question to be asked on said player,
(3) a token question, such that movement of a players playing piece onto said playing position causes a token question to be asked on said player,
(4) a movement action such that a players piece is moved to a predetermined location on said playing surface.

57. The apparatus of claim 52 wherein one token is issued per playing zone.

58. The apparatus of claim 52 wherein more than one token is issued per playing zone.

59. A method of playing a board game that teaches the relationship between at least two separate subject matters to a player or players comprising the steps of:
(1) Providing apparatus that comprises
(a) a question set of “priming questions” as herein defined, said priming questions relating to one subject matter,
(b) a question set of “token questions” as herein defined, said token questions relating to at least two or more subject matters,
(c) one or more substrates to define a playing surface of plural playing zones, each said playing zone relating to an individual subject matter and each said playing zone having,
(i) a pathway of consecutive playing positions, at least one or more marked to indicate association with a priming question, and
(ii) at least one or more marked to indicate association with a token question, and
(iii) each pathway being adapted to continue into or from that of another playing zone,
(d) a movement generator for determining movement of said player or players between said consecutive playing positions,
(e) at least one playing piece per said player or players,
wherein at least one playing position of each said playing zone is associated with a priming question, and
(2) using said movement generator to associate a player's playing piece with a playing position,
(3) when a players playing piece becomes associated with a priming question that player is asked a priming question
(4) if a correct answer is given to a priming question then said player is then asked a token question
(5) if a correct answer is given to a token question then that player achieves a token,
wherein if a player incorrectly answers either a priming question or a token question, then play passes to a different player (if two or more players) who, as per (A) above, is asked a priming question, and
wherein a token question is based upon a combination of at least two or more said subject matters of a playing zone such that correctly answering questions associated with said two or more playing zones facilitates a player to answer a token question and teaches the relationship between said two or more subject matters of said at least two or more playing zones to said player correctly answering a token question.

60. The method of claim 59 wherein said playing surface comprises at least two or more playing zones.

61. The method of claim 59 wherein each said substrate is a playing zone.

62. The method of claim 59 wherein at least one playing area has associated with an additional action (e.g. movement, question, action).

63. The method of claim 62 wherein each said playing position is associated with at least one each of the following
(1) a next turn action (i.e. play passes to a different player),
(2) a priming question, such that movement of a players playing piece onto said playing position causes a priming question to be asked on said player,
(3) a token question, such that movement of a players playing piece onto said playing position causes a token question to be asked on said player,
(4) a movement action such that a players piece is moved to a predetermined location on said playing surface.

64. The method of claim 62 wherein each said player or players receives a token upon correctly answering a token question as an indicator of that player or players progress.

65. Apparatus for an extendable board game played by one or more players comprising
(1) plural substrates (“playing zones”) defining a playing surface, each said playing zone relating to an individual subject matter and each said playing zone having,
(2) a pathway of consecutive playing positions extending between each said at least two playing zones of said playing surface, and
wherein the number of playing zones to be used for the game can be predetermined prior to initiation of the game allowing variation in game length, size and difficulty.

66. The apparatus for an extendable board game of claim 65 wherein each said playing zone corresponds to an individual subject matter.

67. The apparatus for an extendable board game of claim 65 wherein each said playing zone is attachable to another said playing zone to form said playing surface.

68. The apparatus for an extendable board game of claim 65 wherein each playing zone attaches to a plurality of other playing zones.

69. The apparatus for an extendable board game of claim 65 wherein said assembly of playing zones provides a pathway of consecutive playing positions providing a path or paths extending between each of the playing zones forming said playing surface.

70. The apparatus for an extendable board game of claim 65 wherein at least one playing position of each playing zone has associated thereto a question.

71. The apparatus for an extendable board game of claim 65 wherein said board game comprises a plurality of question cards, each having questions and corresponding answers related to said at least one corresponding playing position/question.
